(19) United States
(12) Patent Application Publication
(10) Pub. No.: US 2015/0244855 A1
(43) Pub. Date: Aug. 27, 2015

(54) Providing Assistance to Special Needs Users

(71) Applicant: True-Kare, Serviços e Equipamentos, Lda, Lisbon (PT)

(72) Inventors: José Manuel Correia Serra, Charneca da Caparica (PT); Carlos Manuel dos Santos Azevedo, Lisboa (PT); António Sérgio Baikov Correia Serra, Lisboa (PT); Joao Vasco de Oliveira Redol, Lisboa (PT)

(73) Assignee: True-Kare, Serviços e Equipamentos, Lda, Lisbon (PT)

(21) Appl. No.: 14/192,658

(22) Filed: Feb. 27, 2014

(51) Int. Cl. H04M 1/725

(52) U.S. Cl. CPC H04M 1/72588; H04M 1/72572

(57) ABSTRACT

A technology to provide assistance to special needs users is described. A set of device parameters are received on a mobile device. The set of device parameters include user interface settings and a security perimeter for the mobile device. The mobile device is configured based on the set of device parameters received. An emergency alarm is sent based on whether the location of the device is within the security perimeter.

### BACKGROUND

There is an increasingly aging population in some parts of the world, and likewise a related number of disabling diseases ailing a portion of the population. With this aging population, geriatric medicine has encountered a tide of issues regarding the need for constant monitoring and care of patients, and helping those patients adjust to some loss of independence.

Special needs user (SNU) caregivers, such as family members or friends, are not always able to provide assistance to the SNU 24 hours a day, 7 days a week. Caregivers may constantly fret about the possibility of an SNU emergency and an inadequate response. While mobile devices are very familiar to many people, the elderly and cognitively impaired commonly find mobile device and other modern technologies difficult to use. Moreover, some mobile devices are not customizable or are not customizable to the extent necessary to satisfy the needs of SNUs or other elderly or cognitively impaired users.

### BRIEF DESCRIPTION OF THE DRAWINGS

FIG. 1 is a flow diagram illustrating an overview of an exemplary overview process for providing assistance to special needs users.

FIG. 2 is a component block diagram illustrating an example of a system for providing assistance to special needs users.

FIG. 3 is a flow diagram of an exemplary method for implementing the Menu Configurator Process shown in FIG. 1.

FIG. 4 is a flow diagram of an exemplary method for implementing a location service.

FIG. 5 is a flow diagram of an exemplary method for implementing the Location Targeting Process shown in FIG. 4.

FIGS. 6-7 are flow diagrams of exemplary methods for implementing the Advanced Auto-Answer Process of FIG. 1.

FIGS. 8-9 are flow diagrams of exemplary methods for implementing the Emergency Mode Process shown in FIG. 1.

FIG. 10 is a flow diagram of an example method for providing assistance to special needs users.

FIG. 11 is block diagram illustrating an example of a computing device that may be used for providing assistance to special needs users.

### DETAILED DESCRIPTION

The elderly and other cognitively impaired people have special needs that may require customized solutions for their daily life. These Special Needs Users (SNUs) are often unable to use modern technologies, such as mobile devices, in their day to day life. These SNUs often find mobile devices very confusing with so many features that they may not need or may not use mixed in with features that they may actually find useful. The disclosed technology approaches these problems by providing customization of a mobile device to the actual basic needs of a SNU. In this way, the mobile device may not be as confusing and daunting to the SNU, and more importantly the technology may be used to more readily satisfy the needs of SNUs and their caregivers.

Caregivers of SNUs, including family members, friends and/or a life-care assistance operators (LAO) deal with these and other challenges. For instance, these caregivers may need to easily contact and monitor the SNU, on a daily basis. This ability to contact and monitor the SNU may make it possible for the caregivers to provide the necessary care to the SNU as soon as possible. The technology allows remote configuration of the mobile device. The mobile device may be adapted not only to the SNU's needs, but may also be tailored to the caregivers needs as well. Caregivers may wish to customize the way they monitor, locate and contact the SNU through the mobile device.

The technology provides systems and methods that allow caregivers (e.g. family, friends and/or Life-care Assistance Operators) to remotely configure and monitor the features displayed in a user interface on the mobile device. The mobile device may be communicatively connected to a remote system and may allow for advanced location monitoring of the mobile device. In this way, the mobile device may be adapted to include features for a particular SNU. In this way, the mobile device can accommodate the difficulties that an SNU may have in using modern technologies (e.g. the mobile device). For example, caregivers may realize that an SNU may only use features such as a calendar, a pill manager and a call manager in the mobile device. Thus, caregivers may configure only these features (e.g. a calendar, a pill manager and a call manager) in the SNU's mobile device. The SNU may then be spared from the distraction and confusion of other un-configured features when using or managing the mobile device.

In another example, the caregivers may configure, through a web platform, an emergency mode with a list of contacts that are to be automatically contacted in the case of an emergency. Moreover, the list of contacts may be ordered in a way that allows escalation of the emergency when one or more caregivers are unreachable. The caregivers may assign a button in the mobile device, which upon engagement by the SNU, triggers an emergency mode. This emergency mode may automatically block features and may disable a keypad, thereby preventing the SNU from inadvertently canceling the emergency mode. Further, the emergency mode may send an emergency message to the caregiver LAO, and trigger an auditory and/or visual alarm to be emitted from the mobile device. Moreover, the emergency mode may place emergency calls to the other caregivers in the list of contacts (e.g. friends, family, etc.). These emergency calls may be placed in the order defined by the list of contacts. For example, if the first contact is unreachable, an emergency message may be sent to the first contact, and an emergency call may be placed to the next contact on the list of contact. This list of contacts may continue to be processed by placing emergency calls and sending emergency messages until one of the contacts in the list of contacts responds to the emergency call and/or messages (e.g. by answering the emergency call or otherwise replying to the emergency message). Meanwhile, messages (e.g. voice, text, email, etc.) may be left for contacts on the list of contacts that are unreachable. Thus, the technology allows for a group of caregivers to be contacted in the case of emergency, and the technology further provides a mechanism to anticipate the possibility of unreachable caregivers. In this way, an SNU may be cared for using the technology and caregivers may not be left clueless to emergency situations of the SNU.

In another example, the caregivers may, through a web platform, configure an Advanced Auto-answer mode for bedridden users. The Advanced Auto-answer mode may allow the mobile device to automatically answer an incoming call in a speaker-phone mode after a pre-defined number of rings whenever pre-defined caregivers call the mobile device. Moreover, the mobile device may display a picture or an audio message with the name or description of the caregiver during the pre-defined number of rings. The SNU may thereby avoid having to move in order to answer the mobile device. This ability may be particularly useful to bedridden SNUs or SNUs with other locomotive difficulties. Furthermore, this aspect of the technology may prevent situations in which an SNU is unreachable merely because the mobile device may be out of the SNU's reach, for example. By showing a picture and/or an audio or voice message with a name or description of the caregiver, the SNU may be able to immediately identify which caregiver is calling the mobile device.

In another example, a location service may be configured such that a security perimeter is set up with the ordinary places and the typical hours that the SNU moves. The location service may trigger an alarm in the event that the location service detects that the SNU has made an abnormal movement. Using a friendly interface, a map may be presented to the caregivers through a web interface. The map may allow a caregiver to click and connect the points that the SNU typically visits or is likely to visit. The caregiver may click the points one by one, and thereby draw a security perimeter using the connected points. For example, an SNU may normally go to the coffee house on Main Street and then proceed to the hairdresser, the supermarket and the SNU's son's home on Third Street. The caregiver may also include a margin of error. One example of a margin of error may be up to 500 meters. Thus in this example the SNU may be able to deviate from the security perimeter by up to 500 meters without triggering any unnecessary alarms. The caregivers may also insert the typical hours that the SNU normally visits each point (e.g. the SNU normally goes to the supermarket between 10 and 12 am and to the coffee house from 2 pm to 4 pm) or insert general hours that the SNU is usually active outside of the house (e.g. the SNU is outside of the house between 9 am and 10 pm). With these configurations the technology may allow for a safe and fully personalized monitoring of an SNU. If the SNU leaves the security perimeter and is outside the margin of error, or goes to a point within the security perimeter at an unusual hour (e.g. the SNU goes to the coffee house at 2 am), an alarm may be triggered which may inform the caregiver LAO's platform and emergency calls may be made to other caregivers. Emergency calls to other caregivers may be made in sequential order as defined by the list of contacts. These emergency calls may continue to be made until a contact on the list of contacts answers the emergency call. Additionally, a message with the emergency warning may be sent or left for unreachable caregivers.

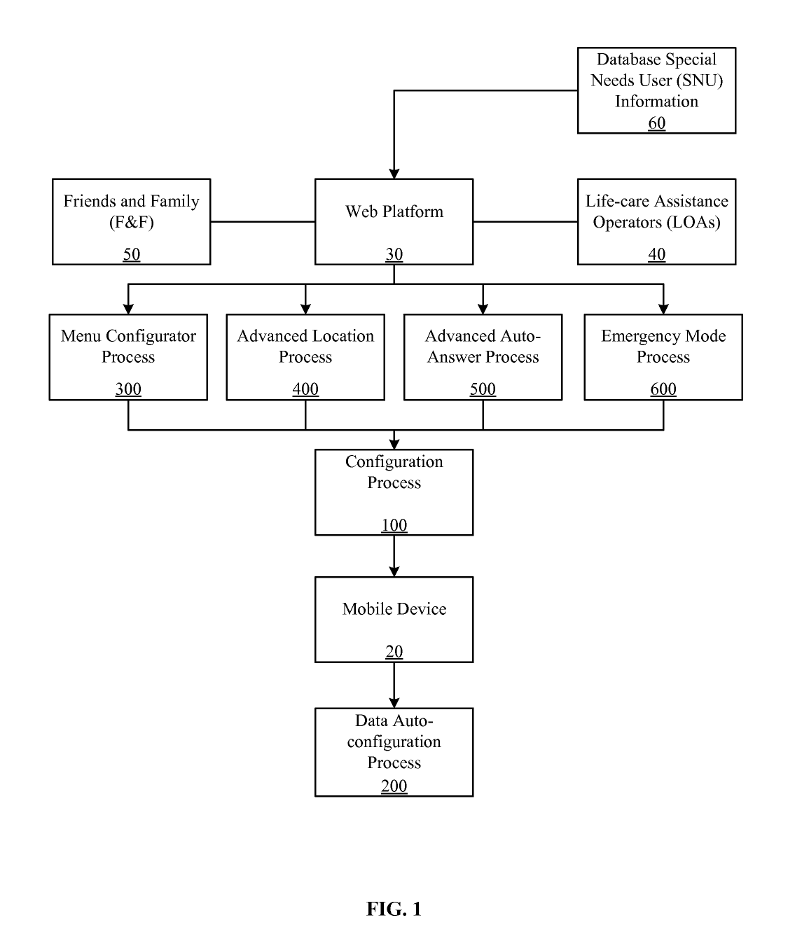

To more clearly describe the technology, examples are now provided with reference to the figures. Accordingly, FIG. 1 is a flow diagram illustrating an overview of an exemplary overview process for providing assistance to special needs users. The process includes the input from a database of special needs user (SNU) information 60 to a web platform 30. The web platform 30 may allow access to various caregivers including friends and family (F&F) 50 and life-care assistance operators (LAOS) 40. The web platform 30 contains a set of device parameters for configuring a menu configurator process 300, an advanced location process 400, an advanced auto-answer process 500 and an emergency mode process 600. The web platform 30 allows users (e.g. caregivers) to activate and output such configurations to a mobile device 20 using a configuration process 100 and through a data auto-configuration process 200.

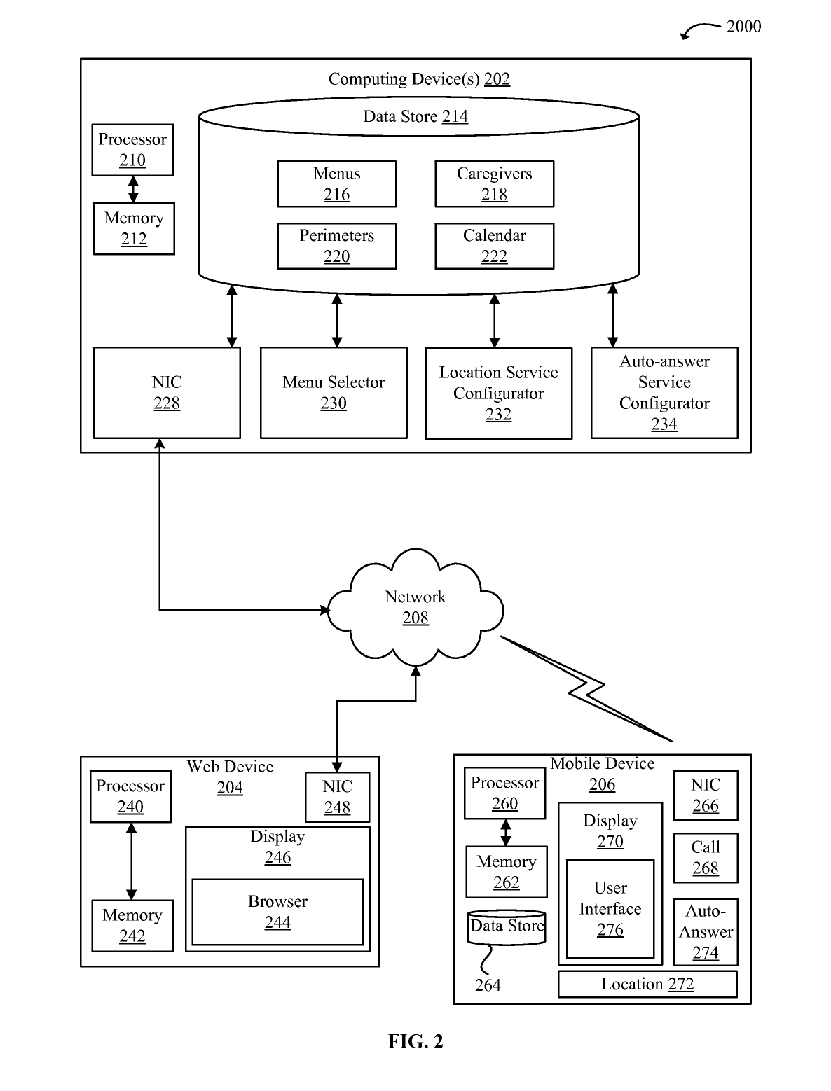

FIG. 2 is a component block diagram illustrating an example of a system 2000 for providing assistance to special needs users. The system 2000 may be used to implement the functionality described herein. The system 2000 may include one or more computing devices 202, a web device 204 and a mobile device 206 connected to the computing device 202 by way of a network 208. The computing device 202 may be a server used to serve pages to the web device 204 and the mobile device 206 which may be used to render and view served pages. Additionally, the computing device 202 may interface with the mobile device 206 through various interface types. The computing device 202 and the mobile device 206, for example, may use a remote procedure call (RPC) interface, or a representational state transfer (REST) interface, as a couple of non-limiting examples.

The computing device 202 may include a data store 214 having various information stored therein including a menus data store 216, a caregivers data store 218, a perimeters data store 220, a calendar data store 222 and other data stores to implement functionality described herein. Additionally, the computing device 202 may include various modules such as a network interface module 228, a menu selector module 230, a location service configurator module 232, an auto-answer service configurator module 234 and other modules to implement functionality described herein. Likewise, the web device 204 and the mobile device 206 may include various modules including a web browser 244, a user interface 276, a call module 268, an auto-answer module 274, a location module 272 or other modules to implement functionality described herein.

The network 208 may include any useful computing network, including a wireless cellular network, an intranet, the Internet, a local area network (LAN), a wide area network (WAN), and/or any other such network or combination thereof, and may utilize a variety of protocols for transmission thereon, including for example, Internet Protocol (IP), the transmission control protocol (TCP), user datagram protocol (UDP) and other networking protocols. Components utilized for such a system may depend at least in part upon the type of network and/or environment selected. Communication over the network may be enabled by wired or wireless connections and combinations thereof.

Based on the aforementioned parameters, the web device 204 may be a device such as, but not limited to, a desktop computer, a laptop, a tablet, a mobile device, a television, a cell phone, a smart phone, a hand held messaging device, a set-top box, a gaming console, a car navigation system, or any device with a display that may receive and present the information.

The computing device 202 may comprise, for example, a server computer or any other system providing computing capability. Alternatively, a plurality of computing devices 202 may be employed that are arranged, for example, in one or more server banks or computer banks or other arrangements. For purposes of convenience, the computing device 202 may be referred to in the singular, but it is understood that a plurality of computing devices 202 may be employed in various arrangements as described above.

Various processes and/or other functionality, as discussed herein, may be executed in the system 2000 according to various examples. The computing device 202, may for example, provide some central server processing services while the web device 204 and the mobile device 206 may provide local processing services and interface processing services to interface with the services of the computing device 202. Therefore, it is envisioned that processing services, as discussed herein, may be centrally hosted functionality or a service application that may receive requests and provide output to other services or customer devices. For example, the web device 204 may have a processor 240 and a memory device 242 to provide processing capabilities. Additionally, the web device 204 may include a display 246 to visually output information to a user. Likewise the mobile device 206 may have a processor 260, a memory 262 and a display 270. Data stores may also be included on the web device 204 and/or the mobile device 206 as shown with the data store 264. Likewise network interface cards (NICs) 248, 266 and associated driver and system software may be included in the web device 204 and the mobile device 206. For instance, the NIC 266 in the mobile device 206 may interface with a wireless cellular network such as a long term evolution (LTE) network as specified by the 3rd Generation Partnership Project (3GPP). The NIC 248 may interface with a gigabit Ethernet network such as that specified by the Institute of Electrical and Electronics Engineers (IEEE) in 802.3.ab which is also known as 1000BASE-T.

For example, services may be considered on-demand computing that is hosted in a server, cloud, grid, or cluster computing system. An application program interface (API) may be provided for each service to enable a second service to send requests to and receive output from the first service. Such APIs may also allow third parties to interface with the service and make requests and receive output from the service. Like the various processing capabilities on the web device 204 and the mobile device 206, a processor 210 may provide processing instructions by communicating with a memory 212 on the computing device 202. That is, the memory device may include instructions operable to be executed by the processor to perform a set of actions. The processor 210 and/or the memory 212 may directly or indirectly communicate with a data store 214.

Various data may be stored in the data store 214 that is accessible to the computing device 202. The term “data store” may refer to any device or combination of devices capable of storing, accessing, organizing and/or retrieving data, which may include any combination and number of data servers, relational databases, object oriented databases, cloud storage systems, data storage devices, data warehouses, flat files and data storage configuration in any centralized, distributed, or clustered environment. The storage system components of the data store 214 may include storage systems such as a SAN (Storage Area Network), cloud storage network, volatile or non-volatile RAM, optical media, or hard-drive type media. The data store 214 may be representative of a plurality of data stores 214.

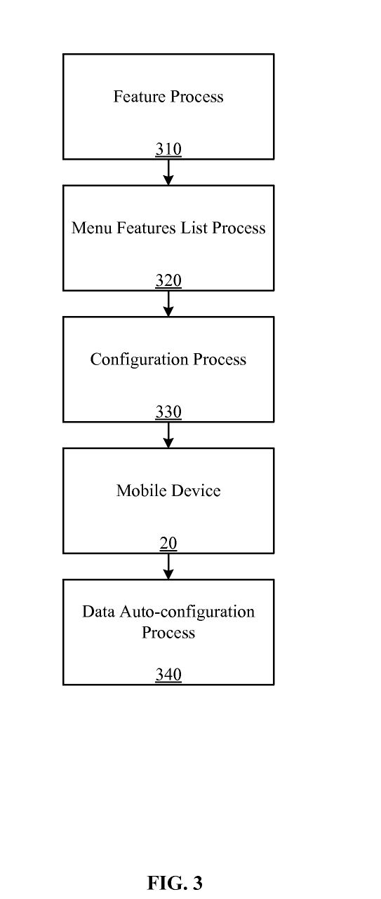

FIG. 3 is a flow diagram of an exemplary method for implementing the menu configurator process 300 shown in FIG. 1. The menu configurator process 300 selects menu features in the web platform 30 using a feature process 310 and a menu features list process 320, and configures the personalized menus into the mobile device 20 using the configuration process 330 and the data auto-configuration process 340. A menu selector specifies menus that are to be displayed in a user interface on the mobile device communicatively connected to the system. This menu selector may allow specification of menus by the caregivers amongst features such as, for example but not limited to, call manager, a simple messaging service (SMS) manager, a multimedia messaging service (MMS) manager, a medication manager, an organizer, and/or a calendar. The user interface may be customizable from a website such that the specified menus are the only displayed in the user interface on the device.

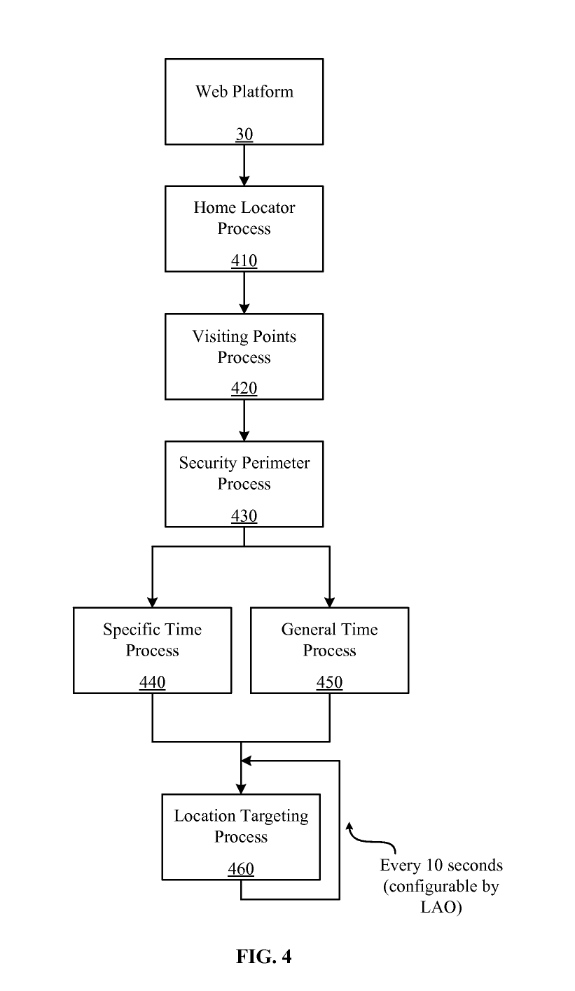

FIG. 4 is a flow diagram of an exemplary method for implementing a location service. The location service includes an advanced location process configurator to specify a security perimeter (e.g. containing the typical locations and/or the normal schedule of the SNU) that may be used to trigger an emergency alarm based on whether the location of the mobile device is within or outside the security perimeter. The security perimeter of the location service may be a non-radial perimeter and may be configured by caregivers in the web platform 30 based on a programmable time schedule using a home locator process 410, a visiting points process 420, a security perimeter process 430, a specific time process 440, a general time process 450, and/or location targeting process 460 (every 10 seconds, which are configurable by the caregivers through the web platform). Both the security perimeter and the programmable schedule may be customizable from a user friendly interface in a website. This location service may include a satellite navigation system, an indoor positioning system, and a mobile wireless network location service.

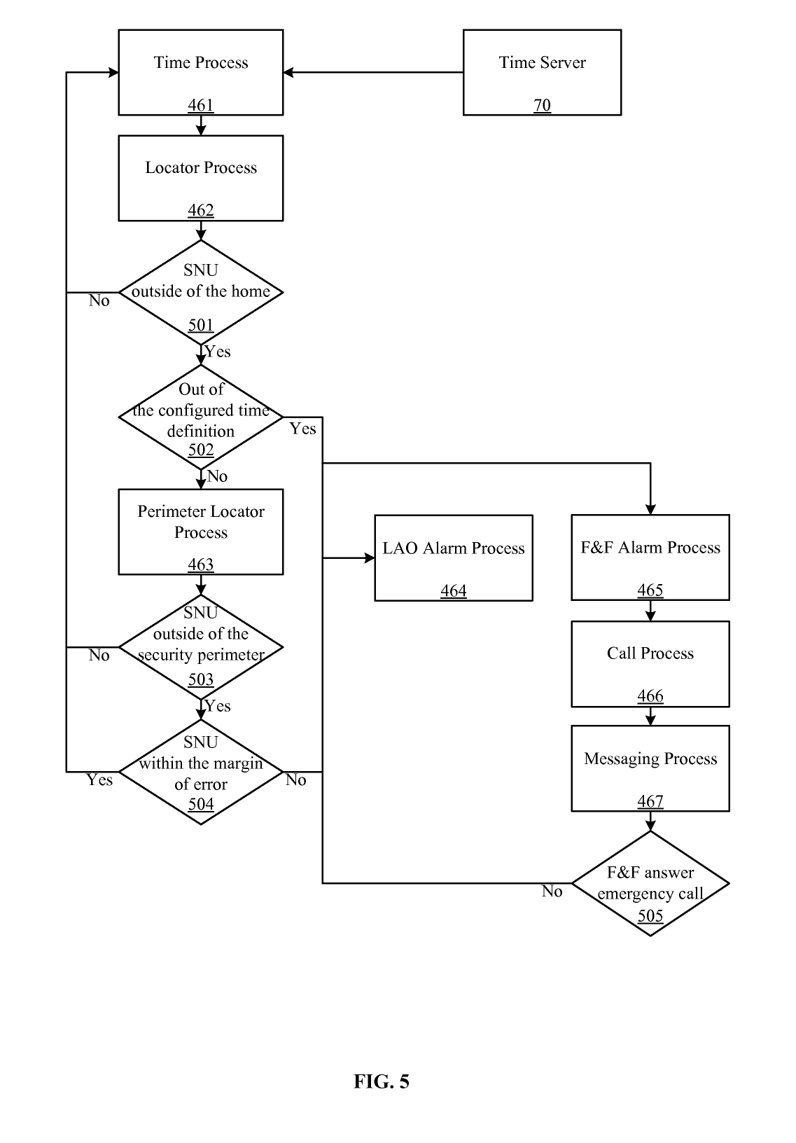

FIG. 5 is a flow diagram of an exemplary method for implementing the Location Targeting Process 460 shown in FIG. 4. The location targeting process may show the input of a time server 70 or getting the current time and analyzing the general time definition (every 10 seconds, which are configurable by the caregivers through the web platform), in time process 461, in order to determine actual SNU's GPS coordinates in locator process 462. Whenever the SNU is outside of home 501 and out of the configured time definition 502 as configured in the advanced location process configurator, a notification may be sent to the caregivers—in the LAO alarm process 464 the notification may also be sent to the software platform. The F&F Alarm Process 465 comprises a messaging process 467, sending a data message over a mobile wireless network to the predefined list of caregivers using the device. The alarm process further comprises a call process 466, dialing a telephone number of a caregiver on the predefined list of caregivers from the device to initiate a telephonic call; waiting for the caregiver to answer the telephonic call 505; playing a pre-recorded message over the telephonic call indicating that there is an emergency; and in case of missed call, running sequentially the pre-defined caregivers contact list restarting the F&F Alarm Process 465, dialing a telephone number of the next caregiver from the device to initiate a telephonic call; and so on until one of the caregivers in the list answers the emergency calling. If the SNU is outside of home 501 but within the configured time definition 502, the perimeter locator process 463 may analyze if the SNU is outside of the security perimeter 503 and if so, whether it is within the margin of error 504 or not. Whenever the SNU is outside the security perimeter 503 and outside the margin of error 504, as configured in the advanced location process configurator, the LAO Alarm Process 464 and F&F Alarm Process 465 may be triggered as defined above.

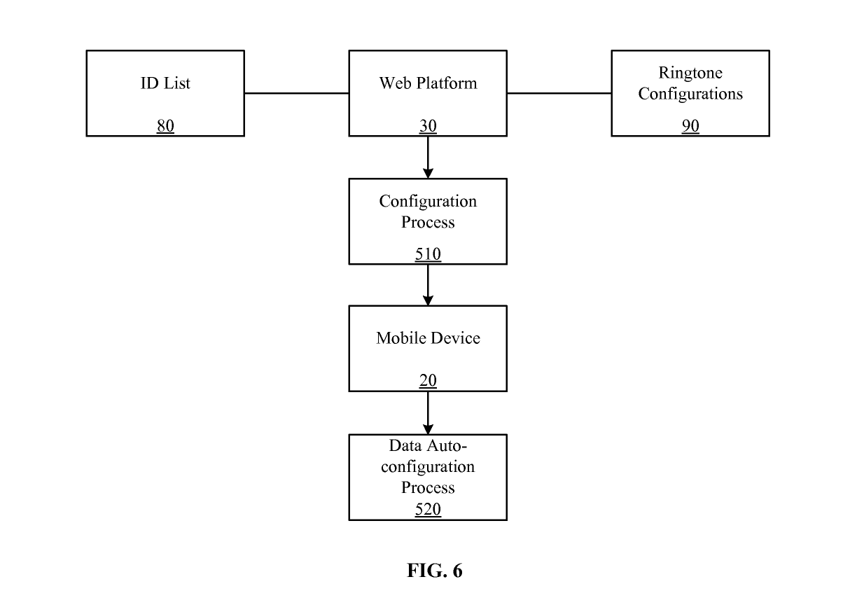

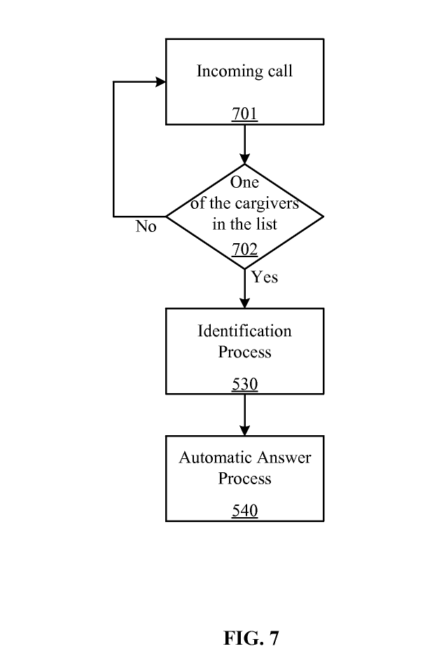

FIGS. 6-7 are flow diagrams of exemplary methods for implementing the advanced auto-answer process of FIG. 1. This method and system for providing assistance to special needs users includes an auto-answer process, auto-answering an incoming call with a call service on a speaker-phone mode when the incoming call is from a predefined caregiver. The configuration process 510 receives the ID List 80 and ringtone configurations 90 in the web platform 30, and configures the caller identity and auto-answer mode into the mobile device 20 using the configuration process 510 and the data auto-configuration process 520. The method, upon an incoming call 701 on the mobile device, if the caller is from one of the caregivers in the pre-defined list 702, outputs the caller identity of the identification process 530, wherein the caller identity of the incoming call is output by at least one of a displayed photograph or icon of the predefined caregiver, an audio message with the name or description of the predefined caregiver, and a displayed text with the name or description of the predefined caregiver, and wherein the set of device parameters includes a caller identity output, which may be customizable from a website. If the incoming call is from one of the caregivers of the list the automatic answer process 540 answers the call automatically on speaker-phone mode.

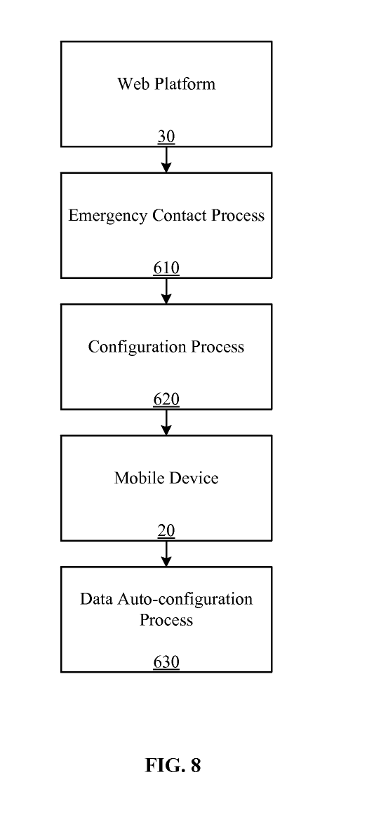

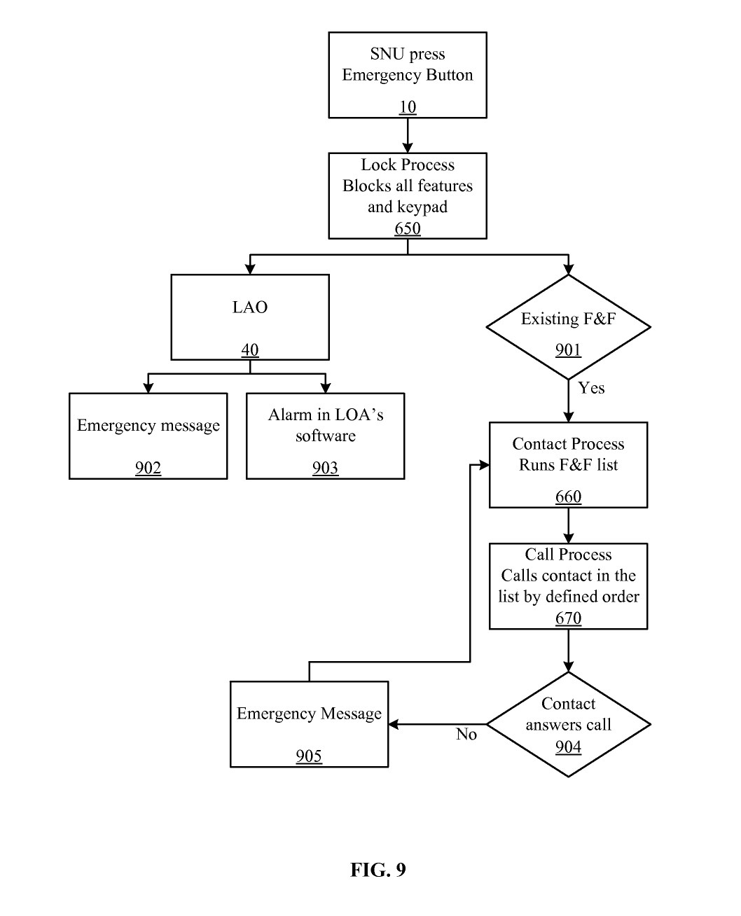

FIGS. 8-9 are flow diagrams of exemplary methods for implementing the Emergency Mode Process shown in FIG. 1. The caregivers defines the list of the caregivers to be contacted and the order of contact in the web platform 30, using an emergency contact process 610, and configures the personalized emergency mode into the mobile device 20 using the configuration process 620 and the data auto-configuration process 630. The method and system for providing assistance to special needs users further includes an Emergency Process by pressing an emergency button 10 (defined by the caregivers), activating an emergency service starting with a lock process to block features and keypad 650 on the mobile device 20, convey emergency audio or video effects from the device, and a notification may be sent to the to the caregivers—in case of the caregivers LAO the alarm includes an emergency message 902 and an alarm in the LAOs software platform 903. The notification of the predefined list of caregivers includes sending a data message over a mobile wireless network to the predefined list of caregivers using the device. The notification further comprises the contact process running the F&F list 660, in case of existing F&F 901, dialing a telephone number of a caregiver on the predefined list of caregivers from the device to initiate a telephonic call 670; waiting for the caregiver to answer the telephonic call 904; playing a pre-recorded message over the telephonic call indicating that there is an emergency 905; and in case of missed call, sending an emergency message 905 over a mobile wireless network to the predefined list of caregivers using the device and running sequentially the pre-defined list of caregivers, dialing a telephone number of the next caregiver from the device to initiate a telephonic call; and so on until one of the caregivers in the list answers the emergency calling.

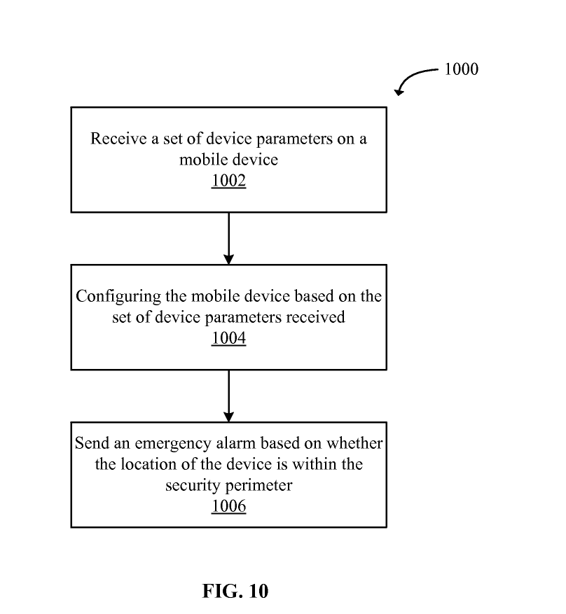

FIG. 10 is a flow diagram of an example method 1000 for providing assistance to special needs users. The method 1000 may include receiving a set of device parameters on a mobile device, as shown in method element 1002. The set of device parameters may include user interface settings and a security perimeter for the mobile device. The method 1000 may also include configuring the mobile device based on the set of device parameters received, as shown in method element 1004. Additionally, the method may include sending an emergency alarm based on whether the location of the device is within the security perimeter, as shown in method element 1006.

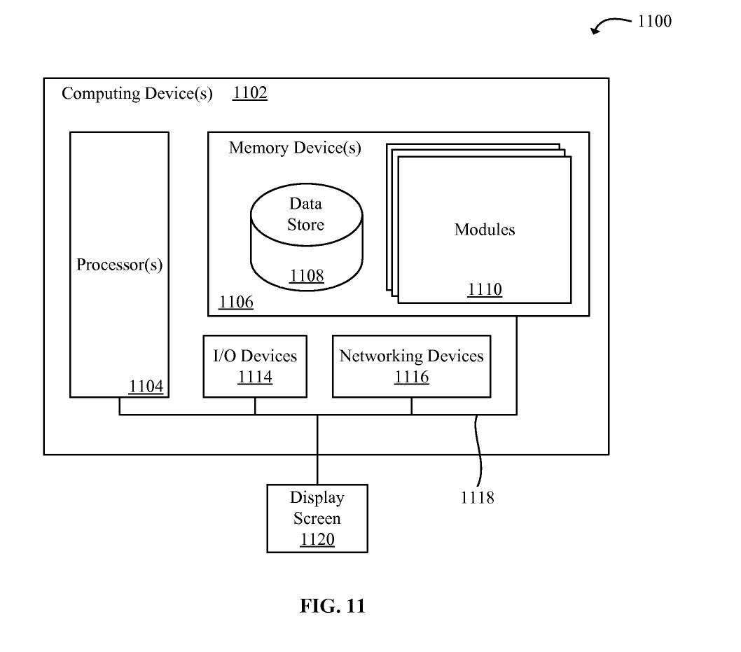

FIG. 11 is a block diagram illustrating an example of a method 1100 that may be used for providing assistance to special needs users. In particular, the computing device 1102 illustrates a high level example of a device on which modules 1110 of the disclosed technology may be executed. The computing device 1102 may include one or more processors 1104 that are in communication with memory devices 1106. The computing device 1102 may include a local communication interface 1118 for the components in the computing device. For example, the local communication interface 1118 may be a local data bus and/or any related address or control busses as may be desired.

In particular, the memory device 1106 may contain modules that are executable by the processor(s) 1104 and data for the modules. Located in the memory device 1106 are modules 1110 executable by the processor to implement the functionality described herein.

A data store 1108 may also be located in the memory device 1106 for storing data related to the modules and other applications along with an operating system that is executable by the processor(s) 1104.

Other applications may also be stored in the memory device 1106 and may be executable by the processor(s) 1104. Components or modules discussed in this description that may be implemented in the form of software using high programming level languages that are compiled, interpreted or executed using a hybrid of the methods.

The computing device may also have access to I/O (input/output) devices 1114 that are usable by the computing devices. An example of an I/O device is a display screen 1120 that is available to display output from the computing devices. Other known I/O devices may be used with the computing device as desired. Networking devices 1116 and similar communication devices may be included in the computing device. The networking devices 1116 may be wired or wireless networking devices that connect to the internet, a LAN, WAN, or other computing network.

The components or modules that are shown as being stored in the memory device 1106 may be executed by the processor(s) 1104. The term “executable” may mean a program file that is in a form that may be executed by a processor 1104. For example, a program in a higher level language may be compiled into machine code in a format that may be loaded into a random access portion of the memory device 1106 and executed by the processor 1104, or source code may be loaded by another executable program and interpreted to generate instructions in a random access portion of the memory to be executed by a processor. The executable program may be stored in any portion or component of the memory device 1106. For example, the memory device 1106 may be random access memory (RAM), read only memory (ROM), flash memory, a solid state drive, memory card, a hard drive, optical disk, floppy disk, magnetic tape, or any other memory components.

The processor 1104 may represent multiple processors and the memory device 1106 may represent multiple memory units that operate in parallel to the processing circuits. This may provide parallel processing channels for the processes and data in the system. The local communication interface 1118 may be used as a network to facilitate communication between any of the multiple processors and multiple memories. The local communication interface 1118 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules and/or processes, in order to more particularly emphasize their implementation independence. For example, a module or process may be implemented as a hardware circuit comprising custom VLSI circuits or gate arrays, off-the-shelf semiconductors such as logic chips, transistors, or other discrete components. A module or process may also be implemented in programmable hardware devices such as field programmable gate arrays, programmable array logic, programmable logic devices or the like.

Modules and processes may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction or many instructions and may even be distributed over several different code segments, among different programs and across several memory devices. In this way, a module of executable code may be a process when executed by a processor. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A system for providing assistance to special needs users, comprising:
a processor;
a memory device including instructions to be executed by the processor;
a network interface communicatively connect to a mobile device;
a menu selector to specify menus that are displayed in a user interface on the mobile device communicatively connected to the system; and
a location service configurator to specify a security perimeter that is used to trigger an emergency alarm based on whether the location of the mobile device is within the security perimeter,
wherein the network interface communicates settings specified in the system to the mobile device.

2. The system of claim 1, wherein the location service configurator can specify a non-radial perimeter for the security perimeter.

3. The system of claim 1, wherein the location service configurator can specify a schedule to modify the security perimeter.

4. The system of claim 1, wherein the menu selector allow specification of menus from at least one of a call manager, a simple messaging service (SMS) manager, a multimedia messaging service (MMS) manager, a medication manager, an organizer, and a calendar.

5. The system of claim 1, further comprising an auto-answer service configurator to configure a predefined caregiver for automatic answer on the mobile device.

6. The system of claim 1, further comprising a caregiver identifier to configure an output produced on the mobile device on an incoming call including at least one of a displayed photograph or icon of a predefined caregiver, an audio message with a name or description of the predefined caregiver, or a displayed text with the name or description of the predefined caregiver.

7. The system of claim 1, further comprising an emergency service configurator to configure a list of caregivers for the mobile device to notify when an emergency service is activated on the mobile device.

8. A non-transitory computer usable medium having a computer readable program code embodied therein, said computer readable program code adapted to be executed to implement a method for providing assistance to special needs users, comprising:
connecting a device to a wireless network;
downloading a user interface to the device over the wireless network;
displaying the user interface to enable a user interact with the device;
locating the device with a location service; and
triggering an emergency alarm based on whether the device is within a security perimeter,
wherein the user interface is customizable from a website such that specified menus are displayed in the user interface on the device.

9. The non-transitory computer usable medium of claim 8, wherein the security perimeter is a non-radial perimeter.

10. The non-transitory computer usable medium of claim 8, wherein the location service modifies the security perimeter based on a programmable schedule.

11. The non-transitory computer usable medium of claim 10, wherein the security perimeter and the programmable schedule are customizable from a website.

12. The non-transitory computer usable medium of claim 8, wherein the location service includes at least one of a satellite navigation system, an indoor positioning system, or a mobile wireless network location service.

13. The non-transitory computer usable medium of claim 8, wherein the user interface that is customizable from the website includes specified menus from at least one of a call manager, a simple messaging service (SMS) manager, a multimedia messaging service (MMS) manager, a medication manager, an organizer, or a calendar.

14. The non-transitory computer usable medium of claim 8, further comprising auto-answering an incoming call with a call service on a speaker-phone mode when the incoming call is from a predefined caregiver.

15. The non-transitory computer usable medium of claim 14, wherein a caller identity of the incoming call is output by at least one of a displayed photograph or icon of the predefined caregiver, an audio message with a name or description of the predefined caregiver, or a displayed text with the name or description of the predefined caregiver.

16. The non-transitory computer usable medium of claim 15, wherein the caller identity output on the device is customizable from a website.

17. The non-transitory computer usable medium of claim 8, further comprising activating an emergency service based on engagement of a component on the user interface to block features on the device, convey emergency audio or video effects from the device, and notify a predefined list of caregivers.

18. A method for providing assistance to special needs users, comprising:
under control of one or more computer systems configured with executable instructions:
receiving a set of device parameters on a mobile device, the set of device parameters including user interface settings and a security perimeter for the mobile device;
configuring the mobile device based on the set of device parameters received; and
sending an emergency alarm based on whether a location of the device is within the security perimeter.

19. The method of claim 18, further comprising outputting a caller identity upon receiving a telephonic call on the mobile device, wherein the caller identity of the incoming call is output by at least one of a displayed photograph or icon of a predefined caregiver, an audio message with a name or description of the predefined caregiver, or a displayed text with the name or description of the predefined caregiver, and wherein the set of device parameters includes a caller identify output.

20. The method of claim 18, wherein the set of device parameters includes a list of predefined caregivers to engage an auto-answer service on the mobile device that automatically answer an incoming telephonic call.

21. The method of claim 18, further comprising activating an emergency service to block features on the device, convey emergency audio or video effects from the device, and notify a predefined list of caregivers.

22. The method of claim 21, wherein notifying the predefined list of caregivers comprises sending a data message over a mobile wireless network to the predefined list of caregivers using the device.

23. The method of claim 21, wherein notifying the predefined list of caregivers comprises:
dialing a telephone number of a caregiver on the predefine list of caregivers from the device to initiate a telephonic call;
waiting for the caregiver to answer the telephonic call; and
playing a pre-recorded message over the telephonic call indicating that there is an emergency.
